(19) United States
(12) Patent Application Publication
(10) Pub. No.: US 2026/0279821 A1
(43) Pub. Date: Sep. 17, 2026

(54) ELECTRODE PRECURSOR COMPOSITION

(71) Applicant: Dyson Technology Limited, Malmesbury, Wiltshire (GB)

(72) Inventors: James William DIBDEN, Oxford (GB); Alex MADSEN, Swindon (GB); Daniel Stephen MACPHERSON, Trowbridge (GB); James John RODWAY, Bristol (GB)

(21) Appl. No.: 19/164,676

(22) PCT Filed: Mar. 7, 2024
(86) PCT No.: PCT/IB2024/052208

§ 371 Date: Sep. 12, 2025

(30) Foreign Application Priority Data
Mar. 31, 2023 (GB) 2304782.2

(51) Int. Cl. H01M 4/62; C08K 3/04; H01M 4/04; H01M 4/131; H01M 4/1391; H01M 4/505; H01M 4/525; H01M 10/0525

(52) U.S. Cl. CPC H01M 4/625; C08K 3/041; H01M 4/0433; H01M 4/131; H01M 4/1391; H01M 4/505; H01M 4/525; H01M 10/0525

(57) ABSTRACT

An electrode precursor composition for an alkali metal ion secondary cell. The electrode precursor composition includes a polymer-electrolyte gel matrix phase, a dispersed phase including an electrochemically active material, and a conductive additive. The conductive additive includes a tubular carbon material as a majority component. A method of producing an electrode of the same composition, an electrochemical secondary cell that includes the electrode, and an electrochemical energy storage device that includes the electrochemical secondary cell.

### BACKGROUND

Lithium-ion secondary batteries are the leading battery technology currently used in applications from small personal devices to electric vehicles. Lithium-ion batteries are favoured for their high energy density and long cycle life, among other benefits. They contain a plurality of lithium-ion secondary cells, which is one example of an alkali metal ion secondary cell.

Traditional lithium-ion battery components such as electrodes are made from a solvent cast process that uses sacrificial solvent. This is an energetically expensive step, and a process that avoids using sacrificial solvent is therefore desirable.

One approach to avoiding the use of sacrificial solvent is preparing gel electrodes. These electrodes can be formed from a composition prepared by mixing the necessary components such as electrochemically active material, conductive additive, polymer, and a liquid electrolyte, and subsequently subjecting the composition to a thermal treatment.

The cell manufacturing costs are reduced because the gel components can be produced by simpler processing steps without the need for slow and energy intensive drying of solvent needed for solvent cast electrodes.

### SUMMARY

Despite the advantages of gel-electrode based solid-state cells, it has been found that gel-electrode based solid-state cells may have reduced cell performance in comparison to some conventional cells.

The present inventors have realised that the replacement of some or all of the conventional conductive additives used in gel-electrode based solid-state calls with tubular carbon materials could offer the potential for improved performance of gel-electrode based solid-state cells.

Accordingly, in a first aspect, the present invention provides an electrode precursor composition for an alkali metal ion secondary cell, comprising:
a polymer-electrolyte gel matrix phase; and
a dispersed phase comprising an electrochemically active material and a conductive additive;
wherein the conductive additive comprises a tubular carbon material as a majority component.

The term ‘majority component’ is used herein to define that the component constitutes at least 50 wt % of the conductive additive. Preferably, the conductive additive is 60 wt % or more, 70 wt % or more, 80 wt % or more, 90 wt % or more, 95 wt % or more, 99 wt % or more tubular carbon. The component may also constitute at least 50 vol % of the conductive additive, for example 60 vol % or more, 70 vol % or more, 80 vol % or more, 90 vol % or more, 95 vol % or more, 99 vol % or more tubular carbon

In some embodiments, the conductive additive consists essentially of, or consist of a tubular carbon material. In such embodiments, the electrode precursor composition may not comprise alternative non-tubular conductive additive components. That is, the electrode precursor composition may contain substantially no conductive carbonaceous material other than the tubular carbon materials—e.g. the electrode precursor composition may not comprise graphite, graphene and/or amorphous carbon (such as carbon black). In some embodiments the electrode precursor composition may contain less than 0.5 wt % of conductive carbonaceous materials other than the tubular carbon material, e.g. 0.1 wt % or less, 0.05 wt % or less, or 0.01 wt % or less.

The term ‘tubular carbon’ is used herein to define carbonaceous materials having a generally tubular form. Tubular carbon materials may include, but are not limited to, carbon nanotubes (CNTs) (including SWCNTs and MWCNTs) as well as carbon fibres such as carbon nanofibers (CNFs) and vapor-grown carbon fibres (VGCFs).

The present inventors have found that by providing a conductive additive which comprises tubular carbon as a majority component, electrodes having improved electrochemical performance may result. In particular, the present inventors have found that by providing a conductive additive which comprises tubular carbon as a majority component, the tortuosity values of the resulting electrodes (tortuosity values associated with Li+_diffusion) may be reduced in comparison to electrodes which do not comprise tubular carbon as the majority component of the conductive additive in the electrode. As will be discussed in greater detail below, electrodes produced from electrode precursor compositions according to the first aspect may demonstrate a tortuosity of 2.2 or less, as measured using electrochemical impedance spectroscopy of a symmetric cell incorporating said electrode, e.g. as described in Johannes Landesfeind et al 2016 J. Electrochem. Soc. 163 A1373. When the electrodes have a tortuosity of 2.2 or less, the electrodes may demonstrate suitable ionic resistance to allow for improved performance in high-power applications.

The dispersed phase may consist of, or consist essentially of, the electrochemically active material and the conductive additive. That is, the dispersed phase may comprise substantially no other components in addition to the electrochemically active material and the conductive additive.

The tubular carbon material may be a material selected from single-walled carbon nanotubes (SWCNTs), multi-walled carbon nanotubes (MWCNTs), carbon nanofibers (CNFs), vapor-grown carbon fibres (VGCFs), or mixtures thereof. Preferably, the tubular carbon material comprises, consists essentially of, or consists of, multi-walled carbon nanotubes (MWCNTs). It has been found that use of MWCNTs can provide suitable performance with lower cost and manufacturing complexity than use of SWCNTs or carbon-fibre-based tubular carbon materials.

In some embodiments, the electrochemically active material is a positive active material and the electrode precursor composition is a cathode precursor composition. In these embodiments, the positive active material may be a lithium transition metal oxide material. In some embodiments, the positive active material is a lithium transition metal oxide material comprising a mixed metal oxide of lithium and one or more transition metals, optionally further comprising one or more additional non-transition metals. In some embodiments, the positive active material is a lithium transition metal oxide material comprising lithium and one or more transition metals selected from nickel, cobalt and manganese. In some embodiments, the positive active material is selected from one or more of lithium cobalt oxide (LCO), lithium manganese oxide (LMO), lithium nickel cobalt oxide (NCO), aluminium-doped lithium nickel cobalt oxide (NCA), lithium nickel manganese cobalt oxide (NMC), lithium nickel oxide (LNO), lithium nickel manganese oxide (LNMO), lithium iron phosphate (LFP), lithium manganese iron phosphate (LFP) and lithium nickel vanadate (LNV). In some embodiments, the positive active material is lithium nickel manganese cobalt oxide (NMC), optionally doped with another metal such as aluminium. Such positive active materials are commercially available or may be manufactured by methods known to the skilled person, for example through the precipitation of mixed metal hydroxide intermediates from a reaction mixture containing different precursor metal salts, followed by calcination to form a mixed metal oxide and optionally lithiation to incorporate lithium into the oxide.

The electrochemically active material may be undoped or uncoated, or may contain one or more dopants and/or a coating. For example, the electrochemically active material may be doped with small amounts of one or more metal elements. The electrochemically active material may comprise a carbon coating on the surface of the particles of the material.

The electrochemically active material may be a particulate material, i.e. materials made up of a plurality of discrete particles. The particles may comprise primary particles and/or secondary particles formed from the agglomeration of a plurality of primary particles.

In some embodiments, the electrochemically active material makes up at least 50 vol % of the electrode precursor composition, based on the total volume of electrode precursor composition, for example at least 55 vol %, at least 60 vol %, at least 62 vol %, at least 64 vol %, or at least 65 vol %. Suitably, in some embodiments, the electrochemically active material may make up about 64 vol % of the electrode precursor composition.

As noted above, the dispersed phase further comprises a conductive additive which comprises a tubular carbon material as a majority component. In some embodiments, the conductive additive is present in an amount of from 0.1 vol % to 10 vol % based on the total volume of electrode precursor composition. For example the conductive additive may make up from 0.3 vol % to 5 vol %, from 0.4 vol % to 4 vol %, from 0.5 vol % to 3 vol % or from 0.55 vol % to 2.5 vol % of the electrode precursor composition. In some embodiments, the conductive additive may make up 1 vol % or more of the electrode precursor composition, for example from 1 vol % to 3 vol % of the electrode precursor composition. Suitably, in some embodiments, the conductive additive may be present in amounts of about 1.29 vol %, 1.89 vol %, or 2.48 vol %.

In some embodiments, the dispersed phase comprises from 1.2 vol % to 5 vol % of the conductive additive, based on the total volume of the dispersed phase, for example the dispersed phase may comprise 1.3 vol % or more, 1.4 vol % or more, 1.5 vol % or more, 1.6 vol % or more, 1.7 vol % or more, 1.8 vol % or more, 1.9 vol % or more, or 2 vol % or more of the conductive additive, based on the total volume of the dispersed phase. The dispersed phase may comprise 4.5 vol % or less, 4 vol % or less, 3.9 vol % or less, 3.8 vol % or less, 3.7 vol % or less, 3.6 vol % or less %, or 3.5 vol % or less % based on the total volume of the dispersed phase.

In some embodiments, the dispersed phase comprises from 95 vol % to 98.8 vol % of the electrochemically active material, based on the total volume of the dispersed phase, for example the dispersed phase may comprise 96 vol % or more, 97 vol % or more or 98 vol % or more of the electrochemically active material. The dispersed phase may comprise 98 vol % or less of the electrochemically active material. The dispersed phase may comprise from 95 vol % to 98 vol %, or from 96.5 vol % to 98 vol % of the electrochemically active material.

In some embodiments, the polymer-electrolyte gel matrix phase is formed from one or more electrolyte components and at least one gelling polymer.

The one or more electrolyte components may include a solvent suitable for use as an electrolyte solvent in a gel electrode, for example an organic solvent. The one or more electrolyte components may include a salt. In some embodiments, the one or more electrolyte components may constitute an electrolyte salt solution or liquid electrolyte.

In some embodiments, the one or more electrolyte components comprises a solvent comprising one or more cyclic or linear carbonate compounds. In some embodiments the solvent comprises one or more cyclic carbonate compounds. In some embodiments the solvent comprises one or more of ethylene carbonate, propylene carbonate, butylene carbonate, vinylene carbonate, fluoroethylene carbonate, fluoropropylene carbonate and γ-butyrolactone.

In some embodiments the solvent comprises a blend of at least two different compounds, for example at least three or at least four different compounds. In some embodiments the solvent comprises a blend of at least two different organic carbonate compounds, for example at least three or at least four different organic carbonate compounds.

Preferably, the electrolyte component(s) comprises a solvent with low vapor pressure and high flash point to enable safe processing. An example of a solvent fulfilling these criteria is propylene carbonate. Accordingly, the one or more electrolyte components may comprise or consist of propylene carbonate, or a blend of propylene carbonate with one or more of the above listed solvents.

In some embodiments, the one or more electrolyte components comprises an alkali metal salt. The alkali metal of the alkali metal salt may be any suitable alkali metal (Group I of the periodic table). The alkali metal salt may be a lithium, sodium, or potassium salt.

The anion of the alkali metal salt may be any suitable anion. Typical anions are known to the skilled person and may be chosen based on the kind of alkali metal. In some embodiments, when the alkali metal is lithium, the anion of the salt comprises a halogen such as fluorine. Examples include BF4-, PF6-, TFSI-, FSI-, OTf-, DFOB- and TDI-.

In some embodiments, the one or more electrolyte components comprises a lithium salt. In some embodiments, the electrolyte comprises a mixture of at least two different lithium salts. Examples of suitable lithium salts include LiPF6, LiBF4, LiTFSI, LiFSI, LiOTf, LiDFOB and LiTDI. Preferably the salt is a thermally stable salt. It has been found that LiPF6 has relatively low thermal stability relative to other available lithium salts, and accordingly use of LiPF6 may be avoided—that is, in some embodiments, the electrolyte component(s) do not include LiPF6.

One or more kinds of alkali metal salt may be used in accordance with the present invention. Typically, but not exclusively, when more than one kind of alkali metal salt is used, they share a common alkali metal.

The polymer-electrolyte gel matrix phase may comprise a gel matrix formed by the gelling of one or more gelling polymers when the polymer(s) absorb a liquid electrolyte. The polymer-electrolyte gel matrix phase therefore comprises a gel comprising the polymer(s) and absorbed liquid electrolyte.

The gelling polymer may comprise one or more gelling polymers independently selected from poly(ethyleneglycol dimethacrylate), poly(ethyleneglycol diacrylate), poly(propyleneglycol dimethacrylate), poly(propyleneglycol diacrylate), poly(methyl methacrylate) (PMMA), poly(acrylonitrile) (PAN), polyurethane (PU), poly(vinylidene difluoride) (PVDF), poly(vinylidene fluoride-co-hexafluoropropylene) (PVDF-HFP), poly(ethylene oxide) (PEO), poly-L-lactic acid (PLA), polystyrene (PS), poly(ethyleneglycol dimethylether), poly(ethyleneglycol diethylether), poly[bis(methoxy ethoxyethoxide)-phosphazene], poly(dimethylsiloxane) (PDMS), polyacene, polydisulfide, polystyrene, polystyrene sulfonate, polypyrrole, polyaniline, polythiophene, polythione, polyvinyl pyridine (PVP), polyvinyl chloride (PVC), polyaniline, poly(3,4-ethylenedioxythiophene) (PEDOT), poly(p-phenylene), poly(triphenylene), polyazulene, polyfluorene, polynaphthalene, polyanthracene, polyfuran, polycarbazole, tetrathiafulvalene-substituted polystyrene, ferrocene-substituted polyethylene, carbazole-substituted polyethylene, polyoxyphenazine, poly(heteroacene), poly[(4-styrenesulfonyl) (trifluoromethanesulfonyl)imide-co-methoxy-polyethyleneglycolacrylate] (Li[PSTFSI-co-MPEGA]), sulfonated poly(phenylene oxide) (PPO), N,N-dimethylacryl amide (DMAAm), lithium 2-acrylamido-2-methyl-1-propane sulfonate (LiAMPS), Poly(lithium 2-Acrylamido-2-Methylpropanesulfonic Acid-Co-Vinyl Triethoxysilane), polyethyleneoxide (PEO)/poly(lithium sorbate), PEO/poly(lithium muconate), PEO/[poly(lithium sorbate)+BF3], PEO copolymer, PEO terpolymer, and NIPPON SHOKUBAI® polymer, or mixtures or co-polymers thereof.

In some preferred examples, the gelling polymer comprises one or more gelling polymers independently selected from poly(vinylidene difluoride) (PVDF), poly(vinylidene fluoride-co-hexafluoropropylene) (PVDF-HFP), poly(methyl methacrylate) (PMMA), poly(ethylene oxide) (PEO), poly-L-lactic acid (PLA) and polystyrene (PS)

In some embodiments, the polymer-electrolyte gel matrix phase makes up from 20 vol % to 50 vol % of the electrode precursor composition, for example from 25 vol % to 45 vol %, from 28 vol % to 42 vol %, from 30 vol % to 40 vol %, from 31 vol % to 39 vol % or from 32 vol % to 38 vol %. Suitably, in some embodiments, the polymer-electrolyte gel matrix phase may make up about 33.52 vol %, about 34.11 vol %, or about 34.72 vol % of the electrode precursor composition.

In some embodiments, the electrode precursor composition is for a lithium-ion secondary electrochemical cell. In some embodiments, the electrode precursor composition is a cathode precursor composition.

A second aspect of the invention is an electrode for use in an alkali metal ion secondary cell comprising:
a polymer-electrolyte gel matrix phase; and
   a dispersed phase comprising an electrochemically active material and a conductive additive;
wherein the conductive additive comprises a tubular carbon material as a majority component.

In some embodiments, the electrode demonstrates a tortuosity of 2.2 or less, as measured using electrochemical impedance spectroscopy of a symmetric cell incorporating said electrode, e.g. as described in Johannes Landesfeind et al 2016 J. Electrochem. Soc. 163 A1373. When the electrodes have a tortuosity of 2.2 or less, the electrodes may demonstrate suitable ionic resistance to allow for improved performance in high-power applications. In some embodiments, the electrode may demonstrate a tortuosity in a range of from 1-2. The tortuosity may be, for example, 1.6 or less, 1.5 or less, 1.4 or less, or 1.3 or less.

In some embodiments, the electrode has an ionic conductivity of 1.2 mS/cm or more, as measured at 30° C. using electrochemical impedance spectroscopy of a symmetric cell incorporating said electrode, e.g. as described in Johannes Landesfeind et al 2016 J. Electrochem. Soc. 163 A1373. For example, the ionic conductivity may be 1.29 mS/cm or more, 1.3 mS/cm or more, 1.4 mS/cm or more, 1.5 mS/cm or more, 1.6 mS/cm or more, 1.7 mS/cm or more, 1.8 mS/cm or more or 1.9 mS/cm or more as measured at 30° C. using electrochemical impedance spectroscopy of a symmetric cell incorporating said electrode.

In some embodiments, the capacity retention of the electrode is 20% or more at a C rate of 10 C, as assessed under standardised conditions in a lithium metal half-cell with glass fibre separator and 70 μl of electrolyte at 45° C. For example, the capacity retention of the electrode may be 25% or more, 30% or more, 35% or more, 38% or more or 39% or more at a C rate of 10 C as assessed under standardised conditions in a lithium metal half-cell with glass fibre separator and 70 μl of electrolyte at 45° C.

In some embodiments, the capacity retention of the electrode is 70% or more at a C rate of 5 C, as assessed under standardised conditions in a lithium metal half-cell with glass fibre separator and 70 μl of electrolyte at 45° C. For example, the capacity retention of the electrode may be 76% or more, 77% or more, 80% or more, 83% or more or 84% or more at a C rate of 5 C as assessed under standardised conditions in a lithium metal half-cell with glass fibre separator and 70 μl of electrolyte at 45° C.

In some embodiments, the electrode is produced by processing an electrode precursor composition according to the first aspect to form a film or coating.

In some embodiments, the processing comprises thermal processing and/or extrusion. The electrode may be an extruded electrode. In other embodiments, the electrode may be a hot-rolled electrode. In other embodiments, the electrode is prepared by extruding an electrode precursor composition according to the first aspect through a die to form a film.

In some embodiments, the electrode is a cathode.

All of the compositional options and preferences set out above for the electrode precursor composition of the first aspect apply equally to the electrode of the second aspect, including the identities and the relative amounts of the various components of the composition, which do not change during the processing of the precursor composition into the electrode.

In some embodiments the thermal processing comprises passing the electrode precursor composition through a roller assembly at a temperature of at least 50° C., for example at least 60° C., at least 70° C., at least 80° C., at least 90° C. or at least 100° C. In some embodiments the thermal processing comprises passing the electrode precursor composition through rollers at a temperature of up to 150° C., for example up to 140° C. or up to 130° C. In some embodiments the thermal processing comprises passing the electrode precursor composition through rollers at a temperature of from 50° C. to 150° C., for example from 60° C. to 150° C., from 70° C. to 150° C., from 80° C. to 150° C., from 80° C. to 140° C., from 90° C. to 140° C., from 100° C. to 140° C. or from 110° C. to 130° C.

The roller assembly may comprise two rollers separated by a small distance such that the electrode is pressed into a thin film when passed through the rollers.

In some embodiments the thermal processing comprises extruding the electrode. In some embodiments the thermal processing comprises extruding the electrode using an extrusion apparatus comprising one or more screw feeding sections and an extrusion die. In some embodiments, the temperature of the die is at least 50° C., for example at least 60° C., at least 70° C., at least 80° C., at least 90° C. or at least 100° C. In some embodiments the temperature of the die is up to 150° C., for example up to 140° C. or up to 130° C. In some embodiments the temperature of the die is from 50° C. to 150° C., for example from 60° C. to 150° C., from 70° C. to 150° C., from 80° C. to 150° C., from 80° C. to 140° C., from 90° C. to 140° C., from 100° C. to 140° C. or from 110° C. to 130° C.

In some embodiments the electrode has a thickness of less than 150 μm, for example less than 100 μm, less than 90 μm, less than 80 μm or less than 70 μm. In some embodiments the electrode has a thickness of from 40 to 150 μm, for example from 40 to 100 μm, from 40 to 90 μm, from 40 to 80 μm, from 40 to 70 μm or from 50 to 70 μm.

In some embodiments the electrode has a thickness of from 40 to 150 μm, for example from 40 to 100 μm, from 40 to 90 μm, from 40 to 80 μm, from 40 to 70 μm or from 50 to 70 μm.

In some embodiments the electrode has a porosity of less than about 5% by volume. In some cases, the porosity of the electrode is less than 5 vol %, less than 3 vol % or less than 2 vol %. To phrase in another manner, the volumetric density of the electrode may be at least 95%, suitably at least about 97% or 98% of the density of a perfectly non-porous electrode.

In some cases, the extruded electrode may form part of an extruded monolith which includes one or more further layers which are present in an electrochemical battery. For instance, the monolith may include a separator layer, and/or may include the other electrode (i.e. the extruded monolith may include both a cathode and anode). The different layers may be coextruded and have different compositions from one another.

A third aspect of the invention provides an electrochemical secondary cell comprising an electrode according to the second aspect. The cell may be an alkali metal ion secondary cell, for example a sodium-ion secondary cell or a lithium-ion secondary cell. Preferably the cell is a lithium-ion secondary cell. In some embodiments the electrochemical secondary cell comprises a first electrode according to the second aspect, wherein the first electrode is a cathode, and a second electrode, wherein the second electrode is an anode, and an electrolyte between the cathode and the anode. In some embodiments the electrochemical secondary cell comprises an electrode according to the second aspect laminated with a current collector, for example a metallic foil.

A fourth aspect of the invention provides an electrochemical energy storage device comprising an electrochemical secondary cell according to the third aspect. In some embodiments, the electrochemical energy storage device is a battery. In some embodiments, the electrochemical energy storage device is a lithium-ion battery.

A fifth aspect of the invention provides a method of preparing an electrode for an alkali metal ion secondary cell, comprising:
mixing a polymer, an electrolyte, an electrochemically active material, and a conductive additive comprising tubular carbon as a majority component, to form an electrode precursor composition according to the first aspect; and
processing the electrode precursor composition to form an electrode film.

In some embodiments, the electrode film has a thickness of from 500 to 700 μm.

In some embodiments, the method further comprises cutting the electrode film to form an electrode of predetermined dimensions.

In some embodiments, the method further comprises performing a second thermal processing step on the cut film to reduce the thickness of the film to within a range of 50 to 70 μm.

In some embodiments, the temperature during thermal processing is 90° C. or more, e.g. from 100 to 140° C.

### EXAMPLES & DETAILED DESCRIPTION

For all samples tested the amount of active material, conductive additive, polymer and electrolyte were determined by calculation of the desired vol % and then conversion of this amount to a desired wt %. The appropriate amounts of each were then weighed and mixed. This mixture was then fed into a twin-screw extruder with three mixing zones at several intervals. The main body of the twin screw extruder was held at 120 degrees over the mixing zones, with a ramp from 40 degrees from the input port and a drop off to 80 degrees at the exit. After this material was fed into the twin-screw extruder it was collected in the form of a granular mixture.

This granular mixture was then rolled into a thin film. Precursor material was fed into a hot roller assembly to create a film of target thickness, typically 50-70 μm depending on formulation.

Gel electrode precursor compositions were prepared according to the compositions shown in Table 1:

| | F1 | | | | | | |
|---|---|---|---|---|---|---|---|
| | (Comparative) | F2 | F3 | F4 | F5 | F6 | F7 |
| Component | Amount / vol % | | | | | | |
| Active grade | 51.20 | 51.20 | | | | | |
| 1 | | | | | | | |
| NMC | | | | | | | |
| Active grade | 12.80 | 12.80 | | | | | |
| 2 | | | | | | | |
| NMC | | | | | | | |
| Active grade | | | 64.00 | 64.00 | 64.00 | 64.00 | 64.00 |
| 3 | | | | | | | |
| NMC | | | | | | | |
| Polymer | 0.48 | 0.48 | 0.48 | 0.47 | 0.47 | 0.47 | 0.47 |
| grade 1 | | | | | | | |
| PVDF/PVDF | | | | | | | |
| copolymer | | | | | | | |
| Polymer | 3.38 | 3.38 | 3.38 | 3.32 | 3.26 | 3.26 | 3.26 |
| grade 2 | | | | | | | |
| PVDF/PVDF | | | | | | | |
| copolymer | | | | | | | |
| Carbon black | 1.29 | | | | | | |
| grade 1 | | | | | | | |
| Carbon black | | | | | | 0.62 | 1.24 |
| grade 2 | | | | | | | |
| Tubular | | 1.29 | 1.29 | 1.89 | 2.48 | 1.86 | 1.24 |
| carbon grade | | | | | | | |
| 1 - | | | | | | | |
| MWCNTs | | | | | | | |
| Electrolyte | 30.86 | 30.86 | 30.86 | 30.32 | | | |
| formulation | | | | | | | |
| 1 | | | | | | | |
| Electrolyte | | | | | 29.79 | 29.79 | 29.79 |
| formulation | | | | | | | |
| 2 | | | | | | | |

Each of the electrode precursor compositions in Table 1 were formed into a gel electrode film by the method set out above.

The tortuosity, ionic and electronic conductivity values (IC, EC) of these electrode films was then measured, with the results being set out in Table 2, below:

| Formulation | IC (mS/cm) | EC (mS/cm) | Tortuosity |
|---|---|---|---|
| code | @ 30° C. | @RT | (dimensionless) |
| F1 | 1.13 | 17.7 | 2.2 |
| (comparative) | | | |
| F2 | 1.74 | 13.1 | 1.4 |
| F3 | 1.90 | 18 | 1.3 |
| F4 | 1.69 | 53 | 1.5 |
| F5 | 1.64 | 127 | 1.3 |
| F6 | 1.37 | 161 | 1.5 |
| F7 | 1.29 | 97 | 1.6 |

These results were determined using electrochemical impedance spectroscopy of a symmetric cell incorporating said electrode, according to methodology described in the following reference: Johannes Landesfeind et al 2016 J. Electrochem. Soc. 163 A1373 Rate performance of the electrode films was then assessed under standardised conditions in a lithium metal half-cell with glass fibre separator and 70 ul of electrolyte, with the results being set in out Table 3, below:

| Formulation | % Capacity retention @45° C. | | | |
|---|---|---|---|---|
| code | 5 C | 10 C | Electrolyte | Separator |
| F1 | 66% | 12.5% | a | GF/F |
| (comparative) | | | | |
| F2 | 76% | 20% | a | GF/F |
| F3 | 77% | 25% | a | GF/A |
| F4 | 83% | 35% | a | GF/A |
| F5 | 83% | 39% | b | GF/A |
| F6 | 84% | 38% | b | GF/A |
| F7 | 83% | 33% | b | GF/A |

It can be shown, by comparing comparative example F1 to example F2 that the ionic conductivity significantly increases from 1.13 mS/cm to 1.74 mS/cm when carbon blacks are replaced with MWCNTS.

By comparing the rate performance of these two examples it is shown that the high-rate performance of example F2 is significantly increased in comparison to comparative example F1, from 12.5% at 10 C to 20%. This is despite the fact that the electronic conductivity of example F2 is considerably lower than example F1.

By comparing examples F3 to F4 it can be shown that it is possible to significantly raise the electronic conductivity of the electrode by increasing the vol % of tubular carbon used as the conductive additive, with only a moderate drop in IC. This results in a considerable improvement in rate performance.

By comparing examples F5 to F6 and F7, it can be shown that replacing the tubular carbons with carbon blacks results in a considerably lower ionic conductivity, and subsequent lower-rate performance, regardless of the changes to electronic conductivity. However, each of these examples which uses 50 vol % or more of tubular carbon shows improved electrochemical performance relative to comparative example F1, with decreased tortuosity, and increased ionic and electronic conductivity as compared with the comparative example comprising no tubular carbon.

All examples according to the invention were seen to demonstrate tortuosity values of 2 or less, specifically of 1.6 or less, thereby showing improvement relative to comparative example F1 which demonstrated a tortuosity of 2.2.

Furthermore, all examples according to the invention were seen to demonstrate ionic conductivity values of 1.29 mS/cm @ 30° C. or more, thereby showing improvement relative to comparative example F1 which demonstrate ionic conductivity value of 1.13 mS/cm @ 30° C.

It is concluded from these examples that the use of tubular carbon materials as a majority component of a conductive additive in an electrode precursor composition can provide for significantly improved electrochemical performance of electrodes formed from said electrode precursor composition. In particular, significant improvements in high-rate performance are seen.

1. An electrode precursor composition for an alkali metal ion secondary cell, comprising:
a polymer-electrolyte gel matrix phase; and
a dispersed phase comprising an electrochemically active material and a conductive additive;
wherein the conductive additive comprises a tubular carbon material as a majority component.

2. The electrode precursor composition according to claim 1, wherein the tubular carbon material constitutes 90 wt % or more of the conductive additive, optionally wherein the conductive additive consists essentially of the tubular carbon material.

3. The electrode precursor composition according to claim 1, wherein the electrode precursor composition contains substantially no conductive carbonaceous material other than the tubular carbon material, optionally wherein the electrode precursor composition contains substantially no graphite, graphene and/or amorphous carbon such as carbon black.

4. The electrode precursor composition according to claim 1, wherein the tubular carbon material comprises or consists of single-walled carbon nanotubes (SWCNTs) and/or multi-walled carbon nanotubes (MWCNTs).

5. The electrode precursor composition according to claim 4, wherein the tubular carbon material consists essentially of multi-walled carbon nanotubes (MWCNTs).

6. The electrode precursor composition according to claim 1, wherein the electrochemically active material is a positive active material.

7. The electrode precursor composition according to claim 6, wherein the electrochemically active material is a lithium transition metal oxide material.

8. The electrode precursor composition according to claim 1, wherein the electrochemically active material makes up at least 50 vol % of the electrode precursor composition, based on the total composition volume.

9. The electrode precursor composition according to claim 1, wherein the electrode precursor composition comprises from 20 vol % to 50 vol % of the polymer-electrolyte gel matrix phase, based on the total composition volume.

10. The electrode precursor composition according to claim 1, wherein the conductive additive is present in an amount of from 0.1 vol % to 10 vol %, based on the total weight/volume of electrode precursor composition.

11. The electrode precursor composition according to claim 1, wherein the polymer-electrolyte gel matrix phase is formed from one or more electrolyte components and at least one gelling polymer, and wherein the gelling polymer comprises one or more gelling polymers independently selected from poly(ethyleneglycol dimethacrylate), poly(ethyleneglycol diacrylate), poly(propyleneglycol dimethacrylate), poly(propyleneglycol diacrylate), poly(methyl methacrylate) (PMMA), poly(acrylonitrile) (PAN), polyurethane (PU), poly(vinylidene difluoride) (PVDF), poly(vinylidene fluoridecohexafluoropropylene) (PVDF-HFP), poly(ethylene oxide) (PEO), poly-L-lactic acid (PLA), polystyrene (PS), poly(ethyleneglycol dimethylether), poly(ethyleneglycol diethylether), poly[bis(methoxy ethoxyethoxide)-phosphazene], poly(dimethylsiloxane) (PDMS), polyacene, polydisulfide, polystyrene, polystyrene sulfonate, polypyrrole, polyaniline, polythiophene, polythione, polyvinyl pyridine (PVP), polyvinyl chloride (PVC), polyaniline, poly(3,4-ethylenedioxythiophene) (PEDOT), poly(p-phenylene), poly(triphenylene), polyazulene, polyfluorene, polynaphthalene, polyanthracene, polyfuran, polycarbazole, tetrathiafulvalene-substituted polystyrene, ferrocene-substituted polyethylene, carbazole-substituted polyethylene, polyoxyphenazine, poly(heteroacene), poly[(4-styrenesulfonyl) (trifluoromethanesulfonyl)imide-co-methoxy polyethyleneglycolacrylate] (Li[PSTFSI-co-MPEGA]), sulfonated poly(phenylene oxide) (PPO), N,N-dimethylacryl amide (DMAAm), lithium 2-acrylamido-2-methyl-1-propane sulfonate (LiAMPS), Poly(lithium 2-Acrylamido-2-Methylpropanesulfonic Acid-Co-Vinyl Triethoxysilane), polyethyleneoxide (PEO)/poly(lithium sorbate), PEO/poly(lithium muconate), PEO/[poly(lithium sorbate)+BF₃], PEO copolymer, PEO terpolymer, and NIPPON SHOKUBAI® polymer.

12. The electrode precursor composition according to claim 11, wherein the one or more electrolyte components include:
(i) a solvent suitable for use as an electrolyte solvent in a gel electrode, for example an organic solvent; and
(ii) a salt.

13. An electrode for use in an alkali metal ion secondary cell comprising:
a polymer-electrolyte gel matrix phase; and
a dispersed phase comprising an electrochemically active material and a conductive additive;
wherein the conductive additive comprises a tubular carbon material as a majority component.

14. The electrode according to claim 13, wherein the electrode has a tortuosity of 2.2 or less, as measured using electrochemical impedance spectroscopy of a symmetric cell incorporating said electrode.

15. The electrode according to claim 13, wherein the electrode has an ionic conductivity of 1.2 mS/cm or more, as measured at 30° C.

16. The electrode according to claim 13, wherein the capacity retention of the electrode is 20% or more at a C rate of 10 C, as assessed under standardized conditions in a lithium metal half-cell with glass fibre separator and 70 ul of electrolyte at 45° C.

17. An electrochemical secondary cell comprising an electrode according to claim 13.

18. An electrochemical storage device comprising an electrochemical secondary cell according to claim 17.

19. A method of producing an electrode comprising:
mixing a polymer, an electrolyte, an electrochemically active material and a conductive additive comprising tubular carbon as a majority component to form an electrode precursor composition according to claim 1; and
processing the electrode precursor composition to form an electrode film.

20. The method of claim 19, wherein the processing comprises thermal processing or extrusion.

21. (canceled)
